(19) United States
(12) Patent Application Publication
(10) Pub. No.: US 2002/0167695 A1
(43) Pub. Date: Nov. 14, 2002

(54) Methods and apparatus for diffractive optical processing using an actuatable structure

(76) Inventor: Stephen D. Senturia, Brookline, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/090,381

(22) Filed: Mar. 4, 2002

Related U.S. Application Data
(60) Provisional application No. 60/272,946, filed on Mar. 2, 2001.

(51) Int. Cl. H04J 14/02

(52) U.S. Cl. 359/130; 359/124

(57) ABSTRACT

A method of redirecting light using an actuatable two-layer diffraction grating structure, the method having applications in wavelength-division multiplexed systems. An optical add/drop modulator (OADM) including an actuatable diffraction grating, for use with a wavelength-division multiplexed signal. An OADM having an optical source located off the main pathway to direct a optical carrier to be added onto the actuatable diffraction grating such that the carrier is diffracted into the main pathway. A detector to measure signal strength for use with an optical processor, the optical processor having an actuatable structure having gaps between the actuated portion of the structure. The detector detecting the portions of light diffracted by the gaps.

### CROSS REFERENCE TO RELATED APPLICATIONS

This application claims the benefit of U.S. Provisional Application No. 60/272,946 filed Mar. 2, 2001, entitled “METHODS AND APPARATUS FOR WAVELENGTH-BASED OPTICAL PROCESSING,” by Senturia. The entirety of the above provisional application is hereby incorporated by reference.

### FIELD OF THE INVENTION

The present invention generally relates to optical processing using an actuatable structure and, more particularly, to methods and apparatus that facilitate a variety of optical processing functions using a diffractive actuatable optical processor.

### DISCUSSION OF THE RELATED ART

A variety of optical processing functions of importance to the field of optical communications are known conventionally. Some conventional optical processing functions manipulate characteristics of optical signals based on particular wavelengths present in the signals to be processed.

For purposes of the present disclosure, the term “wavelength band” refers to a continuous wavelength spectrum over a particular range of wavelengths (e.g., the optical communications “C” band from 1525 to 1570 nanometers, or the “L” band from 1570-1610 nanometers). Similarly, the term “sub-band” as used herein refers to a fraction of a specified wavelength band, and the term “channel” as used herein refers to a specific relatively narrow sub-band having an optical carrier at a particular wavelength that is modulated with an information bearing signal. Accordingly, it should be appreciated that a sub-band (as well as a band) of wavelengths may include one or more channels (i.e., one or more information-bearing carriers having respective different wavelengths).

In view of the foregoing, for purposes of the present disclosure, an “optical signal” refers to a signal comprising one or more channels designated by optical carriers having wavelengths in a range of from approximately 0.2 micrometers to 20 micrometers (i.e., from the ultraviolet through the infrared regions of the electromagnetic spectrum). Optical signals including several channels commonly are referred to as wavelength division multiplexed (WDM) signals.

As mentioned above, in some conventional optical communications applications, two or more channels of a given optical signal may be processed differently based on different wavelengths of the respective carriers for the channels. One example of conventional wavelength-based processing of optical signals is referred to as variable optical attenuation, which relates to a controlled attenuation of optical signals across a particular wavelength band (or sub-band). A device that performs this type of function accordingly is referred to as a “Variable Optical Attenuator,” or “VOA.” For purposes of the present disclosure, the abbreviation VOA is used to refer either to the variable optical attenuation function or a device that performs such a function. In VOA, typically channels lying in a particular wavelength band or sub-band are uniformly attenuated.

Another example of conventional wavelength-based processing is referred to as gain-equalization filtration, and a device that performs this type of function accordingly is referred to as a “Gain-Equalization Filter,” or “GEF.” As above, for purposes of the present disclosure, the abbreviation GEF is used to refer either to the gain-equalization filtration function or a device that performs such a function. In GEF, the attenuation of one or more particular channels of an optical signal within a particular wavelength band or sub-band is controlled, so as to compensate for wavelength-dependent gain variations of an optical amplifier through which the optical signal passes (e.g., an erbium doped fiber amplifier).

One conventional technique for implementing the VOA and GEF optical processing functions discussed above is illustrated schematically in FIG. 1. In the example of FIG. 1, an optical signal 2 is passed through an optical demultiplexer 12 that includes one or more optical elements arranged to achieve some degree of spatial separation between channels having respective different wavelengths within a particular band or sub-band of the optical signal 2. In the illustration of FIG. 1, three different channels (i.e., 2A, 2B, and 2C) of the optical signal 2 are shown to be spatially separated by the optical demultiplexer 12. The spatially separated channels 2A, 2B, and 2C then pass through a spatial light modulator 14 which modifies an intensity of each channel in a predetermined manner. The processed channels 2A′, 2B′ and 2C′ are then recombined into a single processed optical signal 2′ by an optical multiplexer 16, so that the processed optical signal may be directed, for example, into an optical fiber.

One approach to implementing a VOA and GEF involves the use of an actuatable diffraction grating as the spatial light modulator. For example, one optical processor uses a plurality of ribbons cantilevered over a substrates. The plurality of ribbons each have a reflective surface selectively actuatable by applying a voltage between the ribbon and a fixed feature (e.g., a substrate). The ribbons can be actuated to control the diffraction of WDM signal to achieve VOAs or a GEFs. However, optical processing using actuatable diffraction gratings have provided a limited range of optical processing functions. Thus, needs exist for optical processors providing increased features and functionality.

### Summary of the Invention

Some aspects of the present invention are directed to implementing optical add multiplexer (also referred to as an optical adder) using an actuatable diffraction grating. In an optical adder, an optical carrier corresponding to a particular channel of an optical signal is added in a controlled manner (also referred to as channel adding).

Optical adding is a part of a type of optical processing commonly referred to collectively as optical add/drop multiplexing, and a device that performs this type of optical processing accordingly is referred to as an “Optical Add/Drop Multiplexer,” or “OADM.” For purposes of the present disclosure, the abbreviation OADM is used to refer either to the optical add/drop multiplexing function or a device that performs such a function. In OADM, an optical carrier corresponding to a particular channel of an optical signal is added or removed in a controlled manner (These functions are also referred to as channel adding, and channel dropping, respectively). Often, optical signals processed by an OADM may contain several other channels closely spaced in wavelength with respect to the targeted optical carrier to be added or dropped.

Other aspects of the present invention are directed to an optical monitor system to monitor the strength of an optical signal, optical band, sub-band, or optical carrier processed by an optical processor including an actuatable diffraction grating. The optical monitor system includes a detector to detect a portion of the optical signal, optical band, sub-band, or optical carrier, the portion being diffracted by the gaps between adjacent grating elements of said plurality of grating elements of an actuatable diffraction grating.

In view of the foregoing, a first aspect of the invention is an optical processing apparatus for processing a plurality of optical carriers of a wavelength division multiplexed signal comprising a reflective diffracting optical element having a plurality of grating elements forming a plurality of pixels, each pixel configurable to direct a corresponding one of the plurality of optical carriers along a main pathway, an optical source located off the main pathway, positioned to direct an optical carrier to be added onto one of the plurality of pixels of grating elements, the one of the plurality of pixels configurable to diffract at least a portion of the optical carrier to be added into the main pathway, and a controller coupled to the reflective diffracting optical element to configure the plurality of pixels. Optionally the optical processing apparatus may further comprise a substrate, and a plurality of actuating beams supported over the substrate, each of the plurality of actuating beams supporting a corresponding one of the grating elements over the substrate and forming an auxiliary gap. The plurality of actuating beams and the plurality of grating elements are configured such that a displacement of at least one of the plurality of actuating beams toward the substrate causes the corresponding one of the reflective grating elements to be displaced toward the substrate.

In some embodiments of the first aspect of the invention the optical source is an optical fiber. The portion of the optical carrier to be added may be a first order diffraction of the optical carrier to be added. Optionally, the optical processing apparatus may further comprise a demultiplexer optically coupled to the reflective diffracting optical element to achieve spatial separation of the plurality of optical carriers and to project the plurality of optical carriers onto the plurality of pixels of the reflective diffracting optical element.

A second aspect of the invention is an optical processor comprising a reflective diffracting optical element configurable to diffract a first optical carrier along a main pathway, the diffracting optical element having a plurality of parallel grating elements. Adjacent grating elements of said plurality of grating elements are separated by a corresponding one of a plurality of gaps, and the plurality of gaps diffract a portion of the first optical carrier at an angle to the main pathway. A first detector is positioned to receive the portion of the first optical carrier.

Optionally the optical processor of the second aspect may further comprise an optical element to direct the portion of the first optical carrier to the first detector. In some embodiments, the plurality of gaps diffract a portion of a second optical carrier. In other embodiments the optical processor may further comprise a dispersive optical element positioned to receive the portion of the first optical carrier and the portion of the second optical carrier from the reflective diffracting optical element, and to increase spatial separation between the portion of the first optical carrier and the portion of the second optical carrier; the dispersive optical element directs the portion of the first optical carrier to the first detector. Optionally, the optical processor may further comprise a second detector positioned to receive the portion of the second optical carrier. The optical processor may further comprise an actuator to sequentially direct the portion of the first optical carrier and the portion of the second optical carrier to the first detector.

A third aspect of the invention is a method of adding an optical carrier to a wavelength-division multiplexed signal using a diffracting optical element, the diffracting optical element having a plurality of grating elements forming a plurality of pixels, each pixel configurable to direct a corresponding one of a plurality of optical carriers along a main pathway. The method of the third aspect comprises directing the optical carrier from a location off of the main pathway onto one of the plurality of pixels, and configuring the one of the plurality of pixels to diffract at least a portion of the optical carrier into the main pathway. Optionally, the diffracting optical element may include a plurality of actuating beams, each of the plurality of actuating beams supported over a substrate and supporting a corresponding one the grating elements over the substrate, the plurality of actuating beams and the plurality of grating elements configured such that a displacement of at least one of the plurality of actuating beams toward the substrate causes the corresponding one of the reflective grating elements to be displaced toward the substrate. A further option is achieved by configuring the one of the plurality of pixels by actuating at least one of the plurality of actuating beams.

Following below are more detailed descriptions of various concepts related to, and embodiments of, methods and apparatus for wavelength-based optical processing. It should be appreciated that various aspects of the invention as discussed above and outlined further below may be implemented in any of numerous ways, as the invention is not limited to any particular manner of implementation. Examples of specific implementations are provided for illustrative purposes only.

### BRIEF DESCRIPTION OF THE DRAWINGS

FIG. 1 is a schematic illustration of a conventional technique for implementing VOA and GEF optical processing functions;

FIG. 2 is a diagram illustrating an optical signal processing apparatus illustrating one aspect of the invention;

FIG. 3A is a diagram showing a more detailed view of a portion of the apparatus of FIG. 2, according to one aspect of the invention;

FIG. 3B is a top view of an optical processor taken along line 3B-3B of FIG. 3A.

FIG. 4 is a diagram illustrating particular functional aspects of a portion of the apparatus of FIG. 2, according to one aspect of the invention.

FIGS. 5A-5B are schematic side views of support structures for supporting grating elements according to some aspects of the present invention.

FIGS. 6A-6B are schematic side-view diagrams of an example configuration wherein the auxiliary beam is repeated.

FIG. 7 is a side view of a electrostatic optical processor according to some aspects of the invention.

FIG. 8 is a schematic diagram of communications system, commonly referred to as a broadcast-and-select OADM multiplexer system, illustrating aspects of the present invention.

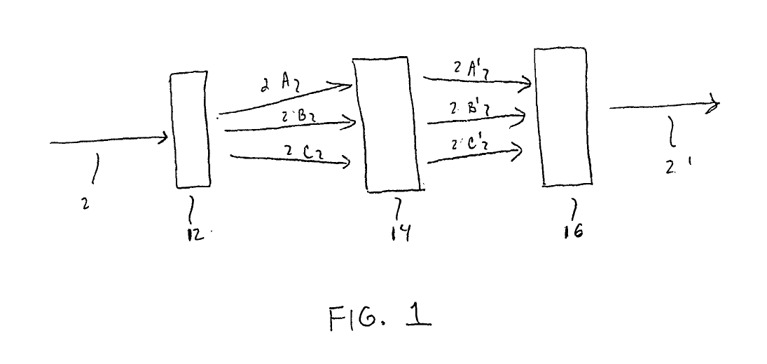

### DESCRIPTION OF THE INVENTION

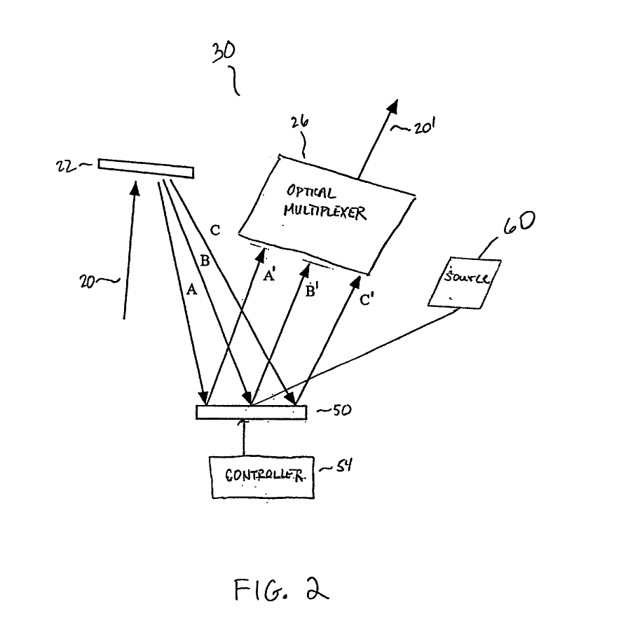

FIG. 2 is a diagram of an optical processing apparatus 30 (also referred to as an optical processor) illustrating aspects of the present invention. In FIG. 2, an optical signal 20 (e.g., from an input optical fiber (not shown) to the apparatus 30) having a number of optical carriers (i.e., signal 20 is a WDM signal) is directed to an optical demultiplexer 22. The optical demultiplexer 22 may include one or more optical elements to spatially separate different wavelengths of the optical signal 20. In one aspect of this embodiment, a fixed transmission or reflection diffraction grating may be employed as the optical demultiplexer 22 (e.g., FIG. 2 illustrates a reflective element for the optical demultiplexer), although it should be appreciated that the invention is not limited in this respect; namely, other types of conventional optical elements may be used for the optical demultiplexer 22.

In one aspect of the invention, the purpose of the demultiplexer 22 is to achieve spatial separation of the optical carriers corresponding to tightly-spaced optical channels within the wavelength-division multiplexed (WDM) optical signal 20. In another aspect, the demultiplexer 22 may provide spatial separation of different wavelength bands or sub-bands of the optical signal 20, wherein each band or sub-band includes one or more optical carriers each corresponding to a different channel. In this aspect, it should be appreciated that although different wavelength bands or sub-bands generally include different channels, in some cases the bands or sub-bands may overlap to some extent; specifically, in some cases, two neighboring wavelength bands or sub-bands may include one or more identical channels, along with other channels that are not included in both bands.

In FIG. 2, the degree of spatial separation provided by the demultiplexer 22 relates to an overall resolution of the optical processing apparatus 30, which may be determined by various design parameters discussed further below. Hence, it should be appreciated that according to one aspect of the invention, the spatial separation provided by the demultiplexer 22 is a matter of design choice, and the invention is not limited to any particular implementation of the demultiplexer 22. Accordingly, in one aspect, the optical processing apparatus 30 may be specifically tailored to accommodate a variety of optical processing applications, based at least in part on the optical signals to be processed.

For purposes of the following discussion, the demultiplexer 22 shown in FIG. 2 is shown as separating the optical signal 20 into three spatially-distinct optical carriers A, B, and C having different wavelengths (i.e., corresponding to different channels). In other embodiments, as discussed above, it should be understood that the separated constituents A, B, and C of the optical signal 20 shown in FIG. 2 alternatively may correspond to different wavelength bands or sub-bands of the optical signal. Of course, it should also be appreciated that the depiction of three different optical carriers (or wavelength bands) in FIG. 2 is for purposes of illustration only, and that the invention is not limited in this respect; namely, any number of optical carriers (or wavelength bands) may be included in the optical signal 20 and spatially separated by the optical demultiplexer 22 at various resolutions.

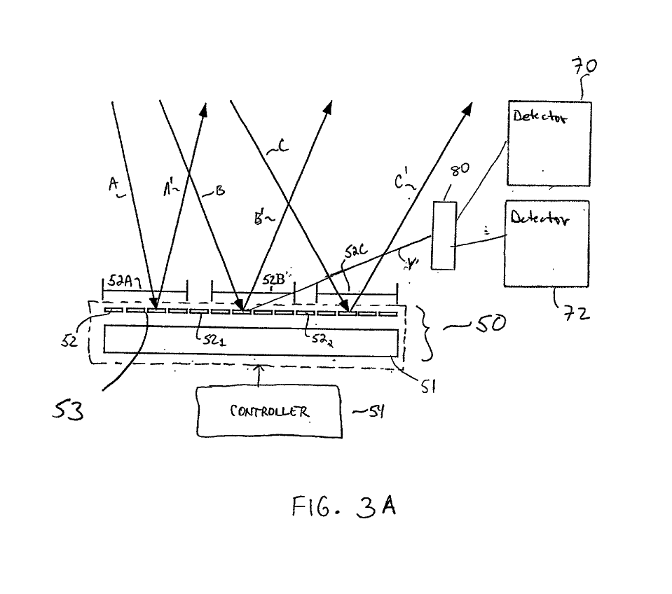

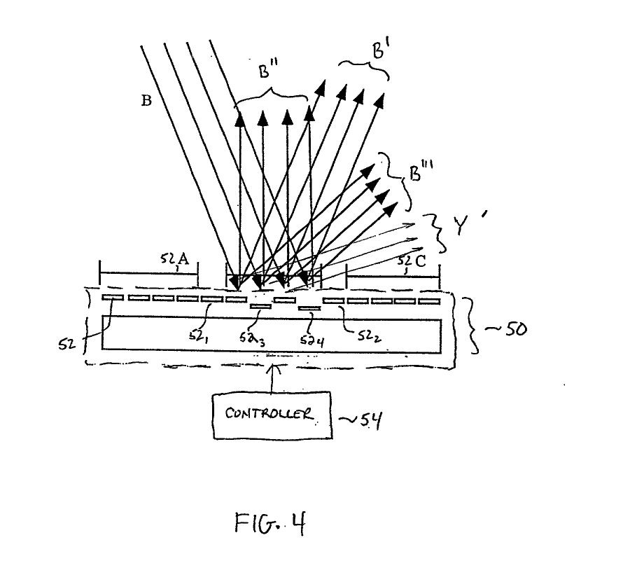

In FIG. 2, the three spatially-separated optical carriers A, B, and C are directed onto the operational surface of a diffractive optical element 50. Although the operational surface of diffractive optical element 50 is understood to be comprised of a plurality of grating elements which do not form a planar or continuous surface, the term “surface” will be used herein to refer to the plurality of grating elements. As described in greater detail with reference to FIGS. 3A, 5A-B, and 6A-B below, according to some aspects of the invention, diffractive optical element 50 may be a diffractive optical processor having grating elements supported by actuating beams.

FIG. 2 also shows the corresponding zeroth-order (i.e., specular reflection) for each optical carrier diffracted by the diffracting optical element 50 as A′, B′, and C′. The zeroth-orders of the diffracted optical carriers are directed, in turn, to an optical multiplexer 26 which recombines the diffracted optical carriers into a single processed optical signal 20′ (so that the processed signal can be directed into an optical fiber, for example). Like the optical demultiplexer 22, the optical multiplexer 26 may include one or more various conventional optical components (e.g., one or more lenses) for focussing the zeroth-orders A′, B′, and C′ of the diffracted optical carriers. For purposes of the following discussion, the path of the optical signal 20 through the optical processing apparatus 30 in FIG. 2, including the separated constituents A, B, and C and the zeroth-orders A′, B′, and C′ of the diffracted optical carriers, is referred to as the “main pathway” through the apparatus.

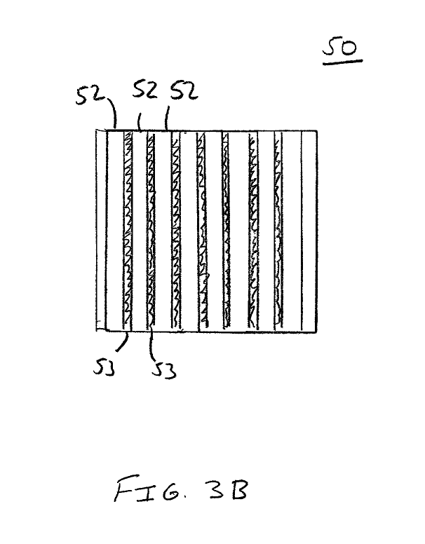

FIG. 2 also shows that, according to one aspect of the invention, the optical processing apparatus 30 includes a controller 54 coupled to the diffracting optical element 50. According to this aspect, the controller 54 is employed to control the diffracting optical element 50 so as to individually and selectively diffract each of the optical carriers A, B, and C impinging on the diffracting optical element 50. In one aspect of this embodiment, the controller 54 and the diffracting optical element 50 are capable of simultaneously controlling the diffraction of each of the optical carriers A, B, and C, wherein each channel may be differently diffracted. The controller 54, as well as one embodiment of the diffracting optical element 50, are discussed in greater detail further below in connection with FIGS. 3 and 4. According to some aspects of the invention, in order to implement the VOA or GEF optical processing functions discussed above, the diffracting optical element 50 is actuated by the controller 54 so as to independently and variably control the main pathway (i.e., zeroth-order) intensity of the various optical carriers.

According to other aspects of the invention, in order to implement OADM optical processing functions, the diffracting optical element 50 is configured (e.g., grating element 52 in FIG. 3A are positioned) so as to substantially reduce the zeroth-order intensity (i.e., the strength along the main pathway) of a particular optical carriers of the optical signal 20 (i.e., a channel dropping function), or to diffract optical radiation to be added from a separate optimally-positioned input (e.g., optical source 60 located off the main pathway) into the main pathway (i.e., a channel adding function). For example, controller 54 configures optical element 50 to achieve dropping or adding. Optical source 60 may be a light generating device such as a laser or light emitting diode, or may be a light transmitting device such as an optical fiber.

According to still other aspects of the invention, to realize a channel adding function, an optical signal provided by an optical source 60 (modulated to realize the optical carrier to be added, the optical carrier corresponding to a channel to be added) may be optimally positioned with respect to the diffracting optical element 50 so that the optical carrier to be added strikes a pixel of the grating such that a non-zeroth order (e.g., a first order) of the diffracted added optical carrier is directed essentially along the main pathway (i.e., along with the zeroth-orders of diffracted channels A′, B′, and C′ shown in FIG. 2) toward multiplexer 26. In this manner, the added optical carrier can be spatially combined with the other optical carriers by the optical multiplexer 26. The term “pixel” is defined herein below with reference to FIG. 3A. From the foregoing, it may be appreciated that the optical processing apparatus 30 of FIG. 2 provides a versatile optical processing mechanism capable of a number of different functions in a single device.

FIG. 3A is an expanded cross-sectional view of one example of a diffracting optical element 50, according to aspects of the invention. For example, in one embodiment, the diffracting optical element 50 may be constructed and arranged as a controllable diffraction grating, as described in U.S. Pat. No. 5,757,536, entitled “Electrically Programmable Diffraction Grating,” U.S. Pat. No. 5,905,571, entitled “Optical Apparatus for Forming Correlation Spectrometers and Optical Processors,” and U.S. Pat. No. 6,329,738 B1, entitled “Precision Electrostatic Actuation and Positioning,” which was incorporated herein above. U.S. Pat. No. 5,757,536, and U.S. Pat. No. 5,905,571 are hereby incorporated herein by reference.

The aforementioned three patents generally describe several embodiments of a controllable diffraction grating, various fabrication methods for such devices, and some exemplary spectroscopy-related applications using such devices. In one particular example, these patents describe technology that facilitates electrostatic actuation of individually actuated mechanical-beam grating elements of a controllable diffraction grating to achieve programmable optical transfer functions.

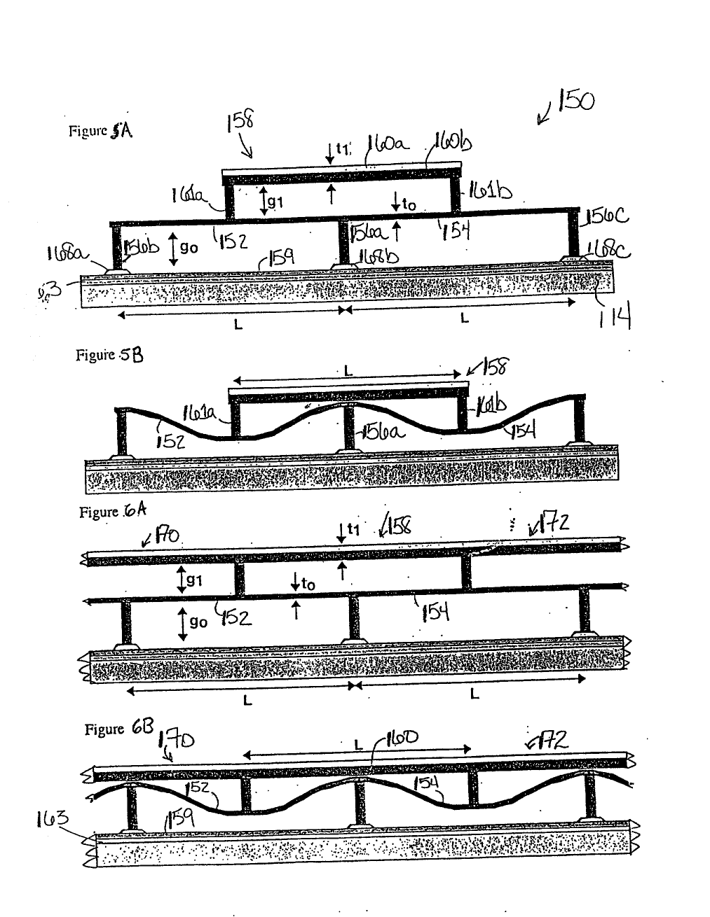

As can be seen from the cross-sectional diagram of FIG. 3A, the diffracting optical element 50, according to one aspect of the invention, comprises a number of essentially parallel thin mechanical beams 52, referred to hereinafter as “grating elements.” In some embodiments of this aspect, the grating elements 52 may be coated with an appropriate coating (e.g., gold) so as to be optically reflective in a particular wavelength range of interest. Additionally, in yet another aspect, the grating elements may be supported on a substrate 51 in a variety of manners. For example, the grating elements can be supported as disclosed in the aforementioned patents. Further details regarding support of grating elements is given in FIGS. 5A-5B and FIGS. 6A-6B below. Particular support mechanisms are not illustrated in FIG. 3A to avoid obfuscation.

According to yet another aspect of the invention, each grating element 52 of the controllable diffraction grating 50 shown in FIG. 3A is capable of being individually actuated (e.g., by the controller 54) so as to effect some physical change of the grating element with respect to other grating elements of the controllable diffraction grating 50. For example, each grating element 52 may be moved with respect to other grating elements by one or both of translational and rotational displacement of the grating element. In particular, each grating element 52 may be independently displaced in a direction essentially normal to a surface of substrate 51 (i.e., in a vertical direction of the cross-sectional perspective shown in FIG. 3A). According to another aspect of the invention, the grating elements 52 may be electrostatically actuated (e.g., the controller 54 outputs a voltage to an electrode associated with a particular grating element so as to displace grating element 52 in the direction of substrate 51), as discussed in the aforementioned patents and patent application. It should be appreciated, however, that the invention is not limited in this respect, as other actuation mechanisms (e.g., thermal, piezoelectric, magnetic) are possible.

As illustrated in FIG. 3A, according to one aspect of the invention, the different optical signals corresponding to optical carriers A, B, and C of the optical signal 20 are spatially separated (by the optical demultiplexer 22 shown in FIG. 2) such that each optical carrier impinges on a corresponding set of at least two grating elements of the diffracting optical element 50. Each set is herein referred to as a “pixel.” The pixels (i.e., their grating elements) are configurable to diffract a corresponding optical carrier. For example, in FIG. 3A, optical carrier A impinges upon a first pixel 52A of four grating elements, optical carrier B impinges upon a second pixel 52B of four grating elements, and optical carrier C impinges upon a third pixel 52C of four grating elements. Although FIG. 3A shows optical carriers A, B, and C only impinging on one grating element of the respective sets, it should be appreciated that this is merely a simplification of the drawing, as each of the optical carriers may actually impinge upon all four of the grating elements in the corresponding pixel.

In the embodiment of FIG. 3A, while four grating elements per pixel are shown for each optical carrier, it should be appreciated that the invention is not limited in this respect, as the number of grating elements included in each pixel may be different according to other embodiments. In particular, as discussed above, the number of grating elements included in each pixel may depend, at least in part, on the dispersion (spatial separation) imparted by the optical demultiplexer 22 shown in FIG. 2, the overall pitch of the grating elements 52 in the diffracting optical element 50, a distance between the optical demultiplexer 22 and the diffracting optical element 50, and the spot size of the optical carrier as projected onto diffracting optical element 50.

According to one aspect of the invention, at least two grating elements are required for each pixel dedicated to a particular channel (or wavelength band) so as to achieve individual and selective diffraction of the optical carrier corresponding to that channel (or wavelength band). In one aspect, the number of grating elements per pixel is chosen to be even, so as to achieve increased diffraction efficiency for a specific channel. Additionally, as illustrated in FIG. 3A, one or more “buffer” grating elements may be designated to separate the respective pixels of grating elements dedicated to diffracting the optical carriers. For example, FIG. 3A indicates a first buffer element 52, between the pixels 52A and 52B, and a second buffer element 522 between the pixels 52B and 52C. Further details on the roles of the buffer grating elements and the number of grating elements employed in general in a given diffracting optical element 50, and design considerations underlying various implementations, are discussed in the patents mentioned above.

In the illustration of FIG. 3A, surfaces of the respective grating elements 52 of the diffracting optical element 50 are shown to lie essentially in the same horizontal plane. This configuration is referred to as an “unactuated” state of the diffracting optical element 50. With the grating elements 52 in these relative positions, most of the radiation from the channels impinging on the diffracting optical element 50 is specularly reflected from the surface of the individual grating elements. However, it should be appreciated that generally there is some loss of radiation due to the periodic presence of lateral gaps 53 between the grating elements 52. While in FIG. 3A, the diffracting optical element 50 typically is designed such that these gaps are small (e.g., about 12% of the total pitch of the grating), in another aspect of the invention, the gaps can be substantially eliminated as described in pending U.S. patent application Ser. No. 09/975,169, filed Oct. 11, 2001, entitled “Actuatable Diffractive Optical Processor,” which is hereby incorporated by reference.

FIG. 3B is a top view of optical processor 50 taken along line 3B-3B′ in FIG. 3A. FIG. 3B illustrates that optical optical processor 50 has a plurality of parallel grating elements 52, each pair of adjacent grating elements being separated by a gap 53.

Referring again to FIG. 3A, in view of the foregoing, a reasonable estimate for the total intensity loss in the main pathway signal due to the diffracting optical element 50 may be given by the percentage of the gaps between the grating elements 52 to the total pitch of the optical element 50. Hence, if the gap constitutes 12% of the pitch, then approximately 12% of the main pathway signal is lost into the gaps. Additionally, in one embodiment, the presence of the gaps diffracts approximately 2% of the radiation impinging on the diffracting optical element 50; accordingly, this diffraction effect due to the gaps increases the total loss due to the gaps in the foregoing example to approximately 14% (corresponding to an insertion loss of approximately 0.65 dB in intensity).

In the embodiment of FIG. 3A, the direction of the diffracted radiation Y′ due to the gaps between the grating elements 52 is at an angle to the main pathway radiation. Hence, according to one aspect of this embodiment, the gap-diffracted radiation can be received by a detector 70 for monitoring an intensity of the optical signal being processed. The gap-diffracted radiation may be collected and directed to detector 70 via one or more other optical elements 80. In one embodiment, optical elements 80 may include a dispersive optical element 80 (e.g., similar to the optical demultiplexer 22) so as to achieve greater spatial separation of the gap-diffracted radiation from each of the optical carriers. In this manner, gap-diffracted radiation from each of the optical carriers may be directed to physically distinct detectors (e.g., detectors 70, 72) so as to individually monitor an intensity of optical carriers corresponding to one or more channels (e.g., optical carriers A, B, and C) of the optical signal. According to some aspects of the invention, optical element 80 includes an actuator, such as a conventional mirror, prism, or acousto-optical device disposed in a path of the gap-diffracted radiation Y′ to allow the gap diffracted radiation Y′ to be scanned in angle so as to sweep each channel in sequence across a detector 70, thereby providing a periodic sequential monitoring of channel intensity using a single detector.

FIG. 4 is a diagram similar to the detailed view of FIG. 3, illustrating particular functional aspects of a portion of the apparatus of FIG. 2, according to one embodiment of the invention. In particular, FIG. 4 illustrates the individual actuation of some of the grating elements 52 of the diffracting optical element 50 so as to modify the main pathway (i.e., zeroth-order) intensity of a particular optical carrier (i.e., the optical carrier B) of the optical signal 20; accordingly, the diagram of FIG. 4 represents an “actuated” state of the diffracting optical element 50.

It should be appreciated that while (for purposes of clarity) FIG. 4 only illustrates the optical carrier B and actuation of some of the grating elements of the pixel 52B (i.e., the grating elements 52₃ and 52₄) corresponding to the optical carrier B, the following discussion applies equally to actuation of grating elements in other pixels (e.g., the pixels 52A and 52C) to selectively diffract other optical carriers of the optical signal (e.g., the optical carriers A and C). Additionally, it should be appreciated that the particular grating elements shown as actuated in FIG. 4 are selected for purposes of illustration only, and that other elements or combinations of elements in a given pixel may be actuated to selectively diffract a given optical carrier, as discussed further below.

Furthermore, while FIG. 4 only illustrates selective diffraction of the optical carrier B, it should be appreciated that, according to one aspect of the invention, the diffracting optical element 50 shown in FIG. 4 is capable of simultaneously diffracting multiple optical carriers of an optical signal (e.g., two or more of the optical carriers A, B, and C), such that different optical carriers may be simultaneously, independently, and in some cases differently diffracted.

In FIG. 4, the actuation of the grating elements 52₃ and 52₄ of the pixel 52B (e.g., via the controller 54) and their resulting vertical displacement creates a local diffraction effect for the optical carrier B, diffracting some of the radiation corresponding to the channel B to the left and right of the main pathway (i.e., some of the optical carrier B radiation is diffracted into non-zeroth orders). In FIG. 4, the main pathway (zeroth-order) of the diffracted optical carrier B is indicated as B′, while the other illustrated orders of the selectively diffracted channel B are indicated as B″ and B′″. Because of this diffraction, the intensity of the zeroth-order B′ is reduced; accordingly, the intensity of the zeroth-order B′ of the diffracted optical carrier B can be independently and variably controlled via actuation of one or more grating elements of the corresponding pixel 52B. This same process applies similarly to the other optical carriers (e.g., the optical carriers A and C) of the optical signal to be processed.

In view of the foregoing, it may be understood that to achieve the VOA or GEF functions discussed above, the diffracting optical element 50 of FIG. 4 may be employed in the apparatus of FIG. 2, wherein one or more grating elements of a pixel of grating elements corresponding to a specific channel are actuated so as to achieve the desired degree of attenuation of the optical carrier corresponding to that channel. For the VOA function, in which it is desired generally to have all optical carriers of the optical signal uniformly attenuated, this actuation feature permits fine tuning of the transfer functions in ways that cannot be achieved with elements such as Fabry-Perot interferometers. For the GEF function, not only can high-resolution gain-equalization be achieved using the apparatus described above, but additionally the actuation can be adjusted over time (e.g., to compensate for drifts and aging of one or more amplifiers used to amplify the optical signal). Furthermore, for dynamic adjustment of channel attenuation using the apparatus described above, the actuation can be performed in times on the order of one millisecond.

As discussed above, for some applications of an optical processor according to various aspects of the invention, it may not be necessary to achieve full channel-by-channel resolution of the optical signal to be processed. This situation may arise particularly in connection with the VOA function, which requires generally flat transfer functions, independent of wavelength. In such a case, it is not necessary that the optical demultiplexer 22 shown in FIG. 2 achieves full spatial separation of optical carriers corresponding to individual channels of the optical signal. However, it should be appreciated that typically some degree of wavelength dispersion is preferable so that different wavelength bands or sub-bands impinge upon different grating pixels of the diffracting optical element 50 illustrated in FIGS. 3 and 4; in this manner, the diffracting optical element 50 can implement fine tuning of the flatness of the overall zeroth-order (specular) transfer characteristic of wavelength bands or sub-bands on an individual and selective basis.

In the embodiment of FIG. 4, the non-zeroth orders B″ and B′″ of the diffracted optical carrier B are at different angles with respect to the zeroth-order B′ than radiation from the optical carrier B that is diffracted by the gaps between the grating, as discussed above (i.e., the gap-diffracted radiation Y′ for the optical carrier B is at about twice the angle to the main pathway as the angle shown for the non-zeroth orders B′ and B′″ in FIG. 4). Hence, according to one embodiment, the non-zeroth orders B″ and B′″ can be collected and directed to another output port of the optical processing apparatus (e.g., for a channel dropping and redirecting function) or to an optical detector (e.g., for an individual channel monitoring function) without interference from the gap-diffracted radiation for the optical carrier B.

Additionally, in one aspect of the embodiment of FIG. 4, to achieve a channel dropping function (e.g., to significantly reduce the intensity of the zeroth-order B′ such that the optical carrier B is effectively or substantially removed from the processed optical signal 20′ (i.e., removed from the main pathway) shown in FIG. 2), appropriate grating elements of the pixel 52B may be displaced by ¼ of the wavelength of the optical carrier B (i.e., when alternate grating elements are displaced by ¼ wavelength, essentially all of the radiation in the channel is diffracted). Typically, however, in this case, 50% of the diffracted radiation is directed to the order B″, and approximately 50% is directed to the order B′″. According to another embodiment of the invention, the grating elements of the pixel 52B may be particularly actuated and other optical elements may be disposed in the path of the non-zeroth orders B″ and B′″ to selectively collect desired radiation so as to obtain as much as 80% of the “removed” optical carrier B to appear at a specific direction; that is the optical carrier is assymetrically diffracted.

The foregoing discussion applies similarly to removing or redirecting other optical carriers corresponding to other channels (e.g., the optical carriers A and C) of the optical signal to be processed. Thus, it should be appreciated that the diffracting optical element 50 of FIG. 4 may be used to drop a given optical carrier of the optical signal from the main pathway and direct the channel radiation to another path, with an ideal loss of approximately 1.65 dB (0.65 dB for the gap loss, 1 dB for the diffraction loss). At least one method of analysis that may be utilized to determine relative displacements of particular grating elements so as to achieve asymmetric diffraction of a given optical carrier is discussed in U.S. Pat. No. 5,905,571, incorporated herein by reference.

As discussed above, according to embodiments of various aspects of the invention, the diffracting optical element 50 shown generally in FIG. 2 may be implemented by a variety of alternative structures that use beam-like grating elements suspended from supports over a substrate and actuated by electrical, mechanical (e.g., piezoelectric), or thermal means. In one embodiment according to some aspects of the invention, the diffracting optical element 50 more specifically shown in FIGS. 3 and 4 may be realized using procedures outlined in U.S. Pat. No. 6,329,738 B1.

Some noteworthy features of diffracting optical elements realized in this manner include, but are not limited to, grating elements that remain flat and parallel to the substrate throughout actuation, small lateral gaps between grating elements (and, hence, low specular reflection gap loss), and undesirable electrostatic pull-in being completely prevented throughout desired actuation ranges. Furthermore, by using a “tiling” procedure for constructing long grating elements as pixel forth in the aforementioned patent application, the shape of the optical surface of the diffracting optical element can be designed to match the optical footprint of the demultiplexed optical signal that impinges on the diffracting optical element. Moreover, by optimizing the design of a repeat unit used to create complete grating elements, the maximum quarter-wavelength travel required for any of the telecommunications optical bands (e.g., 1.3 micrometers, 1.5 micrometers) can be achieved at voltages below 50 V, which is in a range well within the capabilities of commercially available application-specific-integrated circuits.

Based on the various architectures described in the aforementioned patent application, below are provided some exemplary specifications for realizing a diffracting optical element according to some aspects of the invention. It should be appreciated that the specifications provided below are for purposes of illustration only, and that the invention is not limited to employing a diffracting optical element having these specifications. Accordingly, one example of a repeat unit design for a diffracting optical element employs polysilicon grating elements having a length of approximately 300-400 micrometers and having a continuous actuation electrode beneath each grating element. Furthermore, using an approximately two micrometer vertical gap between the electrode and the lower beam, an approximately 1 micrometer thickness of the lower beam, and an approximately 1 micrometer gap between the lower beam and the upper reflective beam (coated with gold), the device is capable of up to approximately 1 micrometer of continuously adjustable vertical travel of each grating element with actuation voltages for each element below 50 Volts. Additionally, if a width of approximately 3.5 micrometers is used for the upper beam and a gap of approximately 0.5 micrometers, an 87.5% fill factor is achieved for a total loss of 14.5% due to the gaps between grating elements (including the small gap diffraction). This corresponds to an unactuated insertion loss attributable to the diffracting optical element of approximately 0.65 dB. If loss due to the optical demultiplexer 22, which generally is on the order of 1 dB, and an additional allowance for losses due to the optical multiplexer 26 (also estimated at approximately 1 dB), is added to the insertion loss for the diffracting optical element, an overall insertion loss of the optical processing apparatus shown in FIG. 2 is estimated to be approximately 2.65 dB, with a reasonable expectation of achieving insertion loss in the 2.65 dB to 3 dB range.

Using the foregoing specifications and assigning four grating elements per channel plus one grating element as a buffer between channels (as illustrated in the embodiment of FIG. 4), the pitch required per channel is 5×4 micrometers or 20 micrometers. Therefore, a width of the optical area of a diffracting optical element similar to that shown in FIG. 4, specifically designed to control 256 channels of an optical signal, would be approximately 5 millimeters, well within the capabilities of standard silicon integrated circuit fabrication methods. Alternatively, if a particular design were to include eight grating elements per channel plus one buffer element, the width of the device would still be less than 1 cm, smaller than a standard modern integrated circuit die.

FIGS. 5A-5B are schematic cross-sectional side views of support structures for supporting grating elements according to some aspects or embodiments of optical processors according to the present invention. For example support structures 150 can be use to support grating elements 52 of FIG. 3A above.

As shown in the figure, there is provided on a substrate 114 two actuating beams 152, 154, each of a common length, L, and each of a common thickness, to; however support structures having actuating beams 152 of differing lengths and/or thicknesses are within the scope of aspects of this invention. The two actuating beams are of an electrically conducting material (e.g., doped silicon) and define central, conducting actuation regions that are supported over a substrate 114 by outer actuation support regions, here provided as support posts 156a, 156b, 156c. The central support post, 156a, is shared by the two beams, but such is not required by the invention. With this support, an actuating gap, go, is defined between the actuating beams and the substrate.

An upper, auxiliary beam 158, including one or more layers 160a (e.g., grating element 52 in FIG. 3A), 160b, of selected material that can be electrically conducting or insulating as-desired, is provided to define a central deflection region that is supported over the actuating beams 152, 154 by auxiliary support regions, here posts 161a, 161b. Posts 161a, 161b, in turn are supported by actuating beams 152, 154 such that the auxiliary beam is supported over substrate 114 by actuating beams 152, 154. The auxiliary beam 156 is of a total selected thickness, t_{I}, and of a length, L, equal to the actuation beams' lengths. The auxiliary beam is suspended over the actuating beams by an auxiliary gap, g₁. Note that with this actuator configuration, the actuating beams' materials, lengths, thicknesses, supports, and lower actuating gap can be specified distinctly from the material, length, thickness, supports, and gap of the auxiliary beam. As a result, the operational characteristics of the actuator can be finely controlled, as described below and in greater detail in co-pending application Ser. No. 10/015,732, incorporated by reference herein above.

A continuous, electrically conducting electrode layer 159 is provided on the surface of the substrate 114, isolated from the substrate by an insulating layer 163. The actuating beam supports each can include an insulating support base 168a, 168b, 168c, to electrically isolate the supports from the continuous electrically conducting layer 161 if the supports are formed of an electrically conducting material. If the actuating beam supports are formed of an insulating, rather than conducting material, such is not required.

Referring to FIG. 5B, when an actuating voltage, V, is applied between the actuating beams and the continuous conducting layer below the beams, with the actuating beams set at electrical ground, the central region of each actuating beam acts as an actuation region and is displaced toward the substrate. When the actuating beams have been actuated such that their actuation regions are displaced downward by an amount equal to the auxiliary gap, g₁, then the deflection region of the auxiliary beam 158 comes to rest on the shared actuation beam support post 156a.

Planarity is maintained along the length of the deflection region of the upper auxiliary beam during this downward displacement of the actuating beams because no part of the auxiliary beam is electrostatically actuated, and because the support posts of the auxiliary beam move downward in unison on the actuation beams. The auxiliary beam itself functions as a planar surface to be moved. Optionally, the auxiliary beam 158 and actuating beams 152, 154 can be coupled to a frame (not shown), and upon downward displacement of the actuating beams, auxiliary beam 158 is maintained with substantially planarity as described in copending U.S. patent application Ser. No. 09/975,169, entitled “Actuatable Optical Processor” by Deutsch et al. U.S., patent application Ser. No. 09/975,169 is hereby incorporated by reference.

As discussed above with reference to FIG. 4, a channel dropping function can be achieved by displacing appropriate grating elements by ¼ of the wavelength of the optical carrier B (i.e., when alternate grating elements are displaced by ¼ wavelength, essentially all of the radiation in the channel is diffracted out of the main pathway and the optical carrier in the main pathway is substantially fully attenuated). A benefit of improved planarity results from the fact that improving planarity across the entire portion of a grating element onto which a projected optical carrier impinges the grating element allows the ¼ of a wavelength displacement to be more nearly maintained across the entire portion of a grating element onto which a projected optical carrier impinges, thus resulting in greater attenuation of the optical carrier to be dropped.

FIGS. 6A-6B are schematic cross-sectional side-view diagrams of an example configuration wherein the auxiliary beam 158 is repeated with adjacent beams 170, 172 and so on, to form a row of auxiliary beams all supported atop a corresponding row of actuation beams. With actuating electrode configuration and operation like that of the structure of FIG. 6B, deflection of the row of lower actuation beams results in planar movement of the row of upper auxiliary beams during the first operational regime characteristic of the structure. As discussed below, this arrangement for providing planar motion can be extended to a wide range of electrostatically actuated structures.

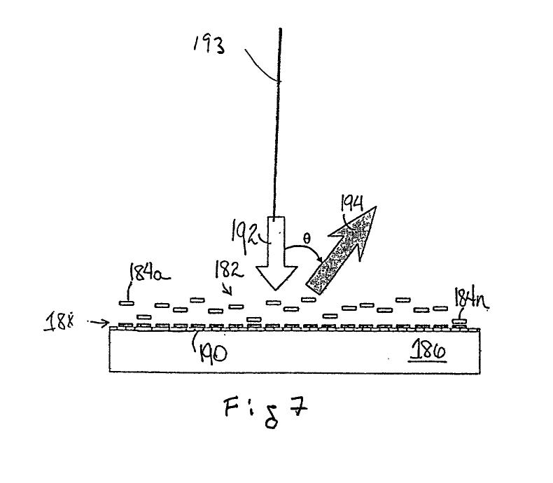

FIG. 7 is a side view of an electrostatic optical processor according to aspects of the present invention. As shown in the figure, the diffraction grating 180 includes an array 182 of a number, n, of flat mirrors (i.e., grating elements) 184a-184n, that are suspended over a substrate 186.

In this example embodiment, the mirrors are electrically conducting and their upper surface is provided with an optically reflecting coating. An actuating electrode array 188 is provided on the substrate, with one electrode or a specified set of electrodes designated for a corresponding suspended mirror. The actuating electrodes are electrically isolated from the substrate by an insulating layer or layers 190 and each can be individually addressed. This enables application of a distinct actuation voltage between each mirror and corresponding actuating electrode, in the manner described previously. With this arrangement, the height of each mirror can be individually electrostatically controlled to enable distinct analog positioning of each of the mirrors.

When light 192 from a broadband source (i.e., a source having a plurality of wavelengths) is directed onto the array of mirrors (e.g., along a main pathway 193), the heights of the mirrors control the optical path length of light reflected from the mirrors. Specifically, the path of a light ray reflected from the grating depends on the height of that mirror from which the ray was reflected. This effect results in a phase shift between reflected light rays, and leads to the formation of a diffracted light beam 194. Collection of this diffracted light beam 194 at an angle, θ, corresponding to the selected mirror heights, enables detection and analysis of wavelength-specific optical information. Thus, the diffraction grating 180 functions as an electrically-programmable optical filter, where the heights of the mirrors implement an optical diffraction transfer function. Accordingly, real time electrostatic analog positioning of the grating mirror heights enables adjustment and modulation of the optical transfer function of the grating.

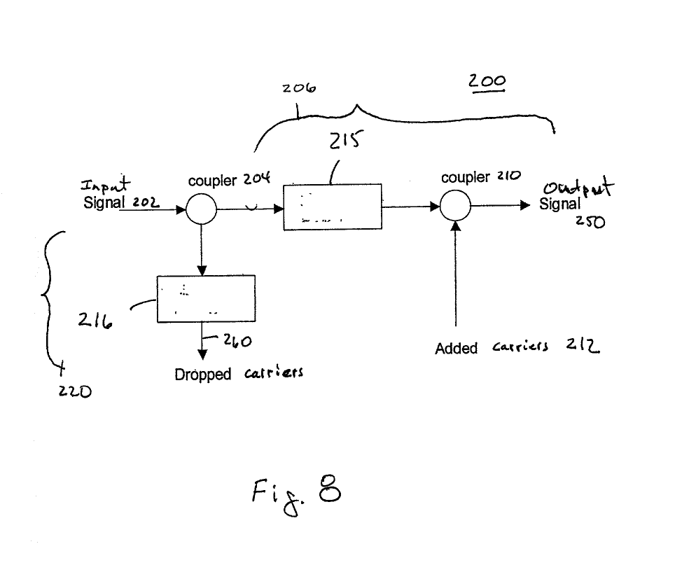

FIG. 8 is a schematic diagram of communications system 200, commonly referred to as a broadcast-and-select OADM multiplexer system, illustrating aspects of the present invention. Communications system 200 illustrates one use of optical processors providing improved planarity, such as optical processors using the support structure described with reference to FIGS. 5A-B and 6A-B. In FIG. 8, optical processors providing improved planarity are used as channel droppers 215, 216 (also referred to as channel blockers).

Optical processor 200 receives an input signal 202 having a plurality of optical carriers (e.g., a WDM signal having 80 optical carriers). Coupler 204 (e.g., a 3 dB coupler) directs a portion of each optical carrier comprising the input signal 202 down each of a first branch 210 and a second branch 220. Channel dropper 215 blocks a first set of one or more of the optical carriers and transmits the remaining optical carriers (i.e., a second set). A coupler 210 (e.g., a 3 dB coupler) allows one or more optical carrier 212 to be added to the first set of carriers to form an output signal 250. The added carriers may correspond to one or more wavelengths of light of the carriers blocked by channel dropper 215.

In communication system 200, according to some aspects of the invention, channel dropper 216 blocks the optical carriers corresponding to the first set of one or more of the optical carriers and transmits the remaining optical carriers (i.e., the second set). The transmitted second set is commonly referred to as the dropped carriers of communication system 200. The dropped carriers are available for further processing at the output 260 of second branch 220.

Although the system above was described having two mutually exclusive sets of optical carriers at outputs 250, 260, outputs may have one or more optical carriers in common. Also, although in the above discussion droppers 215 and 216 were described as blocking optical carriers of input signal 202, it should be understood that droppers 215 and 216 may function to block (i.e., attenuate) empty channels (i.e., channels not having a corresponding optical carrier), thus removing a potential source of amplified spontaneous emission (ASE).

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

1. An optical processing apparatus for processing a plurality of optical carriers of a wavelength division multiplexed signal, comprising:
a reflective diffracting optical element having a plurality of grating elements forming a plurality of pixels, each pixel configurable to direct a corresponding one of the plurality of optical carriers along a main pathway;
an optical source located off the main pathway, positioned to direct an optical carrier to be added onto one of the plurality of pixels of grating elements, the one of the plurality of pixels configurable to diffract at least a portion of the optical carrier to be added into the main pathway; and
a controller coupled to the reflective diffracting optical element to configure the plurality of pixels.

2. The optical processing apparatus of claim 1 further comprising a substrate, and a plurality of actuating beams supported over the substrate, each of the plurality of actuating beams supporting a corresponding one of the grating elements over the substrate and forming an auxiliary gap, the plurality of actuating beams and the plurality of grating elements configured such that a displacement of at least one of the plurality of actuating beams toward the substrate causes the corresponding one of the reflective grating elements to be displaced toward the substrate.

3. The optical processing apparatus of claim 1 wherein the optical source is an optical fiber.

4. The optical processing apparatus of claim 1 wherein the portion of the optical carrier to be added is a first order diffraction of the optical carrier to be added.

5. The optical processing apparatus of claim 1 further comprising a demultiplexer optically coupled to the reflective diffracting optical element to achieve spatial separation of the plurality of optical carriers and to project the plurality of optical carriers onto the plurality of pixels of the reflective diffracting optical element.

6. An optical processor, comprising:
a reflective diffracting optical element configurable to diffract a first optical carrier along a main pathway, the diffracting optical element having a plurality of parallel grating elements, adjacent grating elements of said plurality of grating elements separated by a corresponding one of a plurality of gaps, the plurality of gaps diffracting a portion of the first optical carrier at an angle to the main pathway; and
a first detector positioned to receive the portion of the first optical carrier.

7. The optical processing apparatus of claim 6 further comprising an optical element to direct the portion of the first optical carrier to the first detector.

8. The optical processing apparatus of claim 6 wherein the plurality of gaps diffracts a portion of a second optical carrier.

9. The optical processing apparatus of claim 8 further comprising a dispersive optical element positioned to receive the portion of the first optical carrier and the portion of the second optical carrier from the reflective diffracting optical element, and to increase spatial separation between the portion of the first optical carrier and the portion of the second optical carrier, the dispersive optical element directing the portion of the first optical carrier to the first detector.

10. The optical processing apparatus of claim 8 further comprising a second detector positioned to receive the portion of the second optical carrier.

11. The optical processing apparatus of claim 8 further comprising an actuator to sequentially direct the portion of the first optical carrier and the portion of the second optical carrier to the first detector.

12. A method of adding an optical carrier to a wavelength-division multiplexed signal using a diffracting optical element, the diffracting optical element having a plurality of grating elements forming a plurality of pixels, each pixel configurable to direct a corresponding one of a plurality of optical carriers along a main pathway, comprising:
directing the optical carrier from a location off of the main pathway onto one of the plurality of pixels; and
configuring the one of the plurality of pixels to diffract at least a portion of the optical carrier into the main pathway.

13. The method of claim 12 wherein the diffracting optical element includes a plurality of actuating beams, each of the plurality of actuating beams supported over a substrate and supporting a corresponding one the grating elements over the substrate, the plurality of actuating beams and the plurality of grating elements configured such that a displacement of at least one of the plurality of actuating beams toward the substrate causes the corresponding one of the reflective grating elements to be displaced toward the substrate.

14. The method of claim 12 wherein configuring the one of the plurality of pixels is achieved by actuating at least one of the plurality of actuating beams.
